(19) United States
(12) Patent Application Publication
(10) Pub. No.: US 2018/0220500 A1
(43) Pub. Date: Aug. 2, 2018

(54) SMART OVENS AND OPTIONAL BROWNING TRAYS THEREFOR

(71) Applicant: NEWTONOID TECHNOLOGIES, L.L.C., LIBERTY, MO (US)

(72) Inventors: Fielding B. Staton, Liberty, MO (US); David Strumpf, Columbia, MO (US)

(21) Appl. No.: 15/884,031

(22) Filed: Jan. 30, 2018

Related U.S. Application Data
(60) Provisional application No. 62/452,178, filed on Jan. 30, 2017.

(51) Int. Cl. H05B 6/68; A47J 37/06; A47J 36/02

(52) U.S. Cl. CPC H05B 6/688; A47J 37/0623; H05B 6/687; A47J 36/02; A47J 37/0664

(57) ABSTRACT

Embodiments of smart ovens are disclosed. A smart oven for altering a consumable has a thermally insulated chamber having five walls defining a cavity, and a door hingedly connected to one of the five walls. Electronics are housed within the chamber and include a controller in communication with memory. At least one of the walls of the smart oven is constructed of an intelligent glass panel configured to receive an input and provide a controlled output in response.

### CROSS REFERENCE TO RELATED APPLICATIONS

This application claims priority to U.S. Provisional Patent Application No. 62/452,178, filed Jan. 30, 2017, the disclosure of which is incorporated herein by reference in its entirety.

### FIELD OF THE DISCLOSURE

The disclosure relates generally to the field of microwave and other cooking ovens. More specifically, the disclosure relates to smart defrosting, warming, cooling, and cooking ovens with optional browning trays, herein referenced as a “smart microwave oven.”

### BRIEF DESCRIPTION OF THE SEVERAL VIEWS OF THE DRAWINGS

Illustrative embodiments of the present disclosure are described in detail below with reference to the attached drawing figures and wherein:

FIGS. 1A and 1B are perspective views of a PRIOR ART microwave oven;

FIG. 2 is a perspective view of a smart microwave oven, according to an example embodiment;

FIG. 3 is a front view of an example interface of the smart microwave oven of FIG. 2;

FIG. 4 is a front view of a cavity of the microwave oven of FIG. 2;

FIG. 5 is a front view of an example browning tray situated in the microwave cavity of FIG. 4;

FIG. 6A is a perspective view of the browning tray of FIG. 5;

FIG. 6B is an exploded view of the browning tray of FIG. 5; and

FIG. 7 is a perspective view of the browning tray in use.

### SUMMARY

The following presents a simplified summary of the invention to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

In one embodiment, a smart oven for altering a consumable has a thermally insulated chamber having five walls defining a cavity, and a door hingedly connected to one of the five walls. Electronics are housed within the chamber and include a controller in communication with memory. At least one of the walls of the smart oven is constructed of an intelligent glass panel configured to receive an input and provide a controlled output in response.

In another embodiment, a smart oven for altering a consumable has a thermally insulated chamber with five walls defining a cavity, and a door hingedly connected to one of the five walls. At least one input aperture is defined into one of the walls, and the input aperture is selectively openable and closable. The smart oven further includes electronics housed within the chamber, the electronics including a controller in communication with memory. The electronics cause the at least one input aperture to selectively open and close in response to an input from a user.

In still another embodiment, a smart oven for altering a consumable includes a thermally insulated chamber comprising five walls defining a cavity, and a door hingedly connected to one of the five walls. A browning tray is disposed within the cavity, and has a first layer comprising a selective energy transmission portion; a second layer comprising a crisping tray; and a third layer comprising at least one energy absorbing material. Electronics are housed within the chamber, the electronics comprising a controller in communication with memory for controlling energy waves. The energy transmission portion is configured to selectively attenuate the energy waves.

### DETAILED DESCRIPTION

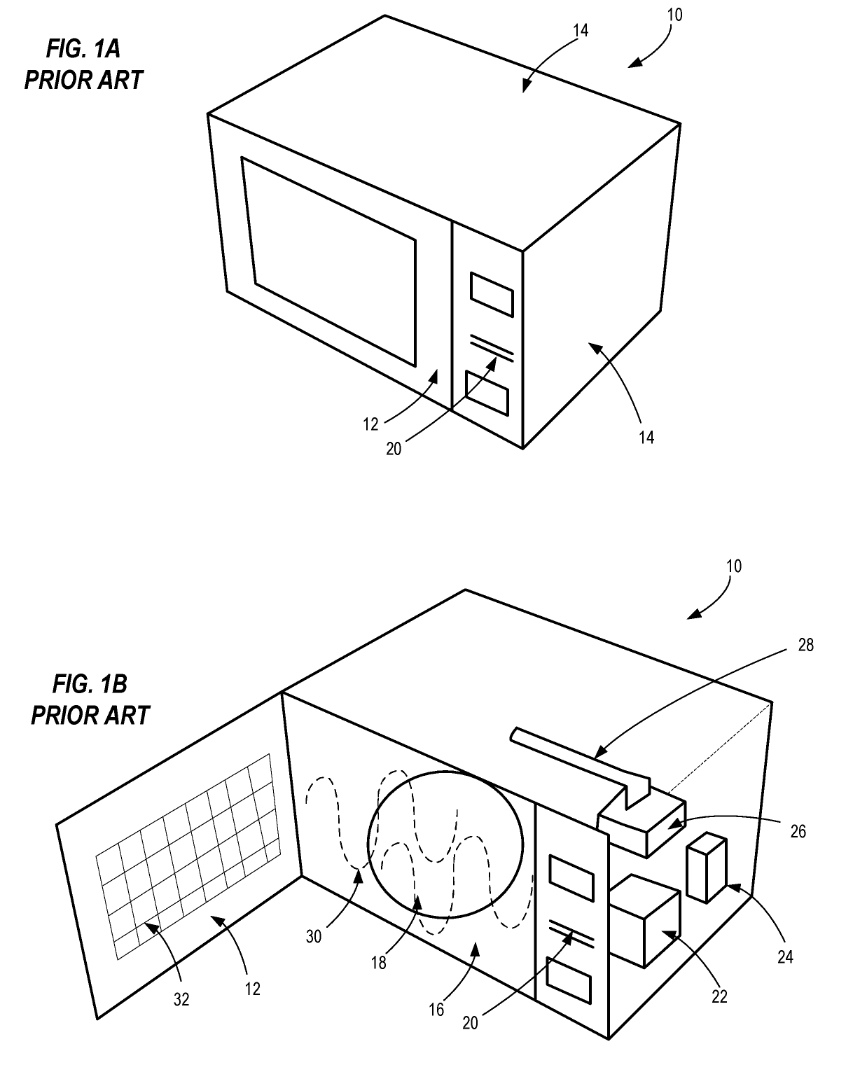

Microwave ovens, invented in the 1940s, are now ubiquitous. Microwave ovens can heat and/or cook food and drink items (herein a “consumable”) faster than conventional convection ovens. FIGS. 1A and 1B show a microwave oven 10 as is known in the art. The prior art microwave oven 10 has an openable door 12, five walls (i.e., a top wall, a bottom wall opposing the top wall, a back wall opposing the door 12, and opposing sidewalls) 14, and a cavity 16 that can be accessed by opening the door 12. A tray 18, which may be configured to be rotatable, is housed within the cavity 16.

The microwave oven 10, also referred to in the industry as simply a microwave, is coupled to a standard outlet (e.g., a 110V or 220V outlet) and includes an input panel 20 that is typically provided adjacent the door 12. When a user desires to heat (e.g., reheat) and/or cook a consumable, he opens the door 12 (by, e.g., depressing a button on the input panel 20 to unlock a mechanical latch) and places the consumable on the tray 18 (e.g., in a separate microwave safe container or directly on the tray 18). The user then uses the input panel 20 to, for example, select a power level (e.g., high, medium, or low) and duration (e.g., one minute, five minutes, twenty minutes, etc.) for which the consumable is to be microwaved.

The microwave 10 has a transformer 22, a capacitor 24, a magnetron 26, and an antenna or other guide 28 in communication with the magnetron 26. The magnetron 26 contains a filament at a center thereof, a circular positive terminal (or anode) that surrounds the filament, and ring magnets which are situated proximate the anode. When the user uses the input panel 20 to activate the microwave oven 10 to heat and/or cook the consumable, the transformer 22 steps up the standard 110V (or 220V) to 4,000V or higher. The high voltage heats the filament at the center of the magnetron 26, which boils off electrons that rush towards the anode in straight lines. The ring magnets proximate the anode, however, bend the electrons back towards the filament such that the electrons fly in a generally circular path. Waves 30 of a particular frequency (typically 2.45 GHz, i.e., microwaves), represented in FIG. 1B by dotted lines, are created as the electrons whip past openings within the anode of the magnetron 26. The antenna 28 transmits the microwaves 30 within the cavity 16.

The microwaves 30 heat up and/or cook the consumable on the tray 18. In general, the microwaves 30 heat up and/or cook the consumable by interacting with the water content of the consumable. Water molecules are positively charged at one end and negatively charged at the other. The positively charged ends of the water molecules within the consumable tend to align themselves with the electric field generated by the microwaves 30, whereas the negatively charged ends of the water molecules point away from the field. Because the field reverses itself many (e.g., 2.45 billion) times a second, the water molecules twist back and forth rapidly. As a water molecule twists rapidly in this fashion, it contacts and rubs against neighboring water molecules, thereby causing friction. This friction in-turn produces heat, which warms up the water within the consumable and allows the consumable to be heated and/or cooked quickly.

Microwaves 30 may be harmful to the human body. The five walls 14 of the microwave 10 are therefore typically made of metal that reflects the microwaves 30 and precludes the microwaves 30 from escaping the cavity 16. The door 12 generally includes a glass panel having a Faraday Cage (e.g., a metal mesh) 32 incorporated therein. The metal mesh 32 is intended to reflect the microwaves 30 but to allow visible light to pass therethrough, so as to enable a user to view through the glass panel of the door 12 the consumable being microwaved without coming into contact with the microwaves 30. When the microwave 10 is in operation, a user can view the consumable being microwaved only through the glass panel of the door 12. The visibility through the Faraday Cage 32 of the door 12, and the microwave radiation blocking ability thereof, is often unsatisfactory.

The microwave 10 (and other microwaves of the prior art), in general, do not heat and/or cook a consumable evenly. This is in part because the various ingredients of the consumable have different rates of energy absorption (due to, for example, different water contents thereof). For instance, the berries in a berry pie generally have more water content than the pie crust, and as such, the berries may absorb microwave energy more efficiently than the crust; when a berry pie is microwaved, the berry filling may heat up and eventually burn while the crust remains cold. The oscillating patterns of the microwaves 30 within the cavity 16 may also cause different portions of the consumable (or different consumables placed simultaneously in the cavity 16) to heat up unevenly. Further, because the microwaves 30 are generally sinusoidal, they do not excite all the consumable particles at once, and thereby create hot spots and cold spots. A rotatable tray 18 may allow the consumable to be heated and/or cooked more evenly as compared to a stationary tray. However, even with the rotatable tray 18, one portion of the consumable may undesirably heat up more than another portion of the consumable (or one consumable may heat up more than another consumable simultaneously placed on the tray 18).

The present disclosure is directed generally (though not solely) to an oven having one or more sensors which function through a distributed network to provide a controlled response in order to tune and detune resonant frequencies so as to overcome adverse effects of materials linked to these sensors. In so doing, the disclosed oven may, among other things, allow for more uniform defrosting, warming, cooling, heating and/or cooking of consumables as compared to prior art ovens. Further, the various components and subcomponents of the oven, and other systems and subsystems, may be configured to communicate over a network to provide for a comprehensive user experience, as is described in greater detail herein. While reference is made herein to a microwave oven, it shall be understood by those of skill in the art that the disclosure is not limited to a microwave oven, and is intended to include other ovens including but not limited to conventional ovens, convection ovens, steam ovens, or any other thermally insulated chamber configured for use in the heating, baking, or drying of a substance.

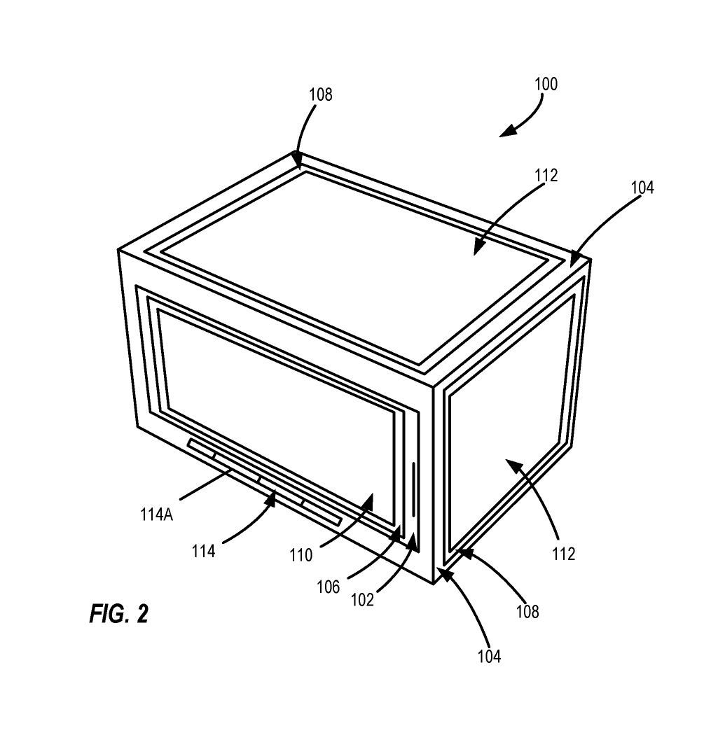

FIG. 2 shows a microwave 100 according to an example embodiment of the present disclosure. The microwave 100 may have an openable door 102 and walls 104 (i.e., a top wall, a bottom wall opposing the top wall, a back wall opposing the door 102, and opposing sidewalls). The microwave 100 may include typical microwave electronics such as a transformer, a wave guide, a magnetron, and may further include other electronics, including a microwave controller in data communication with non-transitory or transitory memory. The microwave controller and memory may be situated at a back side of the microwave 100 or elsewhere outside the microwave cavity. The memory may contain programmable instructions which, when implemented by the microwave controller, allow the microwave 100 to function as discussed herein.

The door 102 may be constructed of glass or another transparent material, and may include a panel 106 configured to selectively reflect energy of certain frequencies and transmit others. In an embodiment, the panel 106 of the door 102 may include a transparent frequency selective surface (or FSS). As is known, an FSS contains holes or other conductive elements in either one or two dimensions that are configured to be illuminated by electromagnetic waves. When so illuminated by the electromagnetic waves, the FSS transmits certain frequencies and reflects others. The skilled artisan understands that the filter characteristics (e.g., which frequencies are to be transmitted and which frequencies are to be reflected) depend largely on the holes/conductive elements (e.g., on the size and shape thereof). In an embodiment, the conductive element of the FSS panel 106 of the door 102 may be a cross shaped aperture having arms of equal length (as in a + sign). A plurality of these cross shaped apertures may be embedded in the FSS panel 106 of the glass door 102. The length of each arm of the cross aperture may be configured so as selectively reflect the 2.45 GHz frequency waves being generated within the microwave 100 while allowing other energy (e.g., visible light, infrared, etc.) to be transmitted in and out of the door 102. For instance, where the FSS panel 106 is configured to transmit 20 GHz frequency waves and block the 2.45 GHz frequency waves, the length of each arm of the cross shaped aperture may be about 0.75 cm (i.e., 20 GHz, which translates to a wavelength of about 1.5 cm, divided by 2). The door 102, via the FSS panel 106, may provide better visibility and better microwave radiation blocking ability as compared to the Faraday Cage 32 of the door 12 of the prior art microwave 10.

In an embodiment, in addition to the door 102, one or more of the walls 104 of the microwave 10 may also be configured to selectively reflect and/or transmit energy. As one example, the walls 104 may be made of glass and comprise a panel 108 having a frequency selective surface as discussed above. The panel 108 of the glass walls 104 may have conductive elements (e.g., a cross aperture) disposed therein that preclude the 2.45 GHz waves from exiting the cavity of the microwave 100 while allowing for the transmission of other energy (e.g., visible light, infrared, etc.). A user may thus be able to view the consumable being microwaved through the one or more walls 104 (in addition to through the door 102). Such added visibility may allow the user enhanced control over the microwaving of the consumable (e.g., the user may be able see through the top wall 104 that a liquid in a container is about to boil and spill over, and may power off the microwave 100 in response).

In some embodiments, the door 102 and the walls 104 may be made of glass and a mesh (e.g., a metal grid like structure such as the Faraday Cage 32) may be provided on the inner surfaces of each of the door 102 and the walls 104. The mesh may include openings sized to preclude the microwaves 30 (which typically have a wavelength of about 12.5 cm) from escaping the microwave cavity while allowing for other energy (e.g., infrared, visible light, etc.) to transmit therethrough.

In embodiments, the door 102, on an outer surface thereof, may comprise an intelligent glass panel 110, and one or more of the walls 104, on their outer surfaces, may additionally comprise an intelligent glass panel 112. The term intelligent glass, as used herein, refers to a single or multi-layered panel that is configured to receive an input and can provide a controlled output in response. The input may be, for example, voltage, light, heat, data, or some other contact or non-contact stimulus. The response may be, for example, a change in the aesthetic appearance of the intelligent glass, or another response. The intelligent glass panels 110 and 112 may include, for example, one or more of smart glass (i.e., electronic glass, privacy glass, switching glass, etc., as is known in the art), an organic LED (OLED) or other LED display, an LCD display, a liquid crystal on silicon (LCOS) display, or any other such single or multi-layered panel that can provide a controlled output in response to a stimulus. In embodiments, the intelligent glass panels 110 and 112 may comprise conventional glass having one or more sensors disposed thereon and/or embedded therein. In embodiments where the intelligent glass panels 110 and 112 comprises multiple layers, one layer may employ technology disparate from the technology employed by another layer (e.g., the intelligent glass panel 110, in an embodiment, may include a layer comprising smart glass and another layer comprising an OLED display). The intelligent glass panel 110 and the intelligent glass panels 112 may, but need not, have the same construction. In some embodiments, the intelligent glass panel 112 on or forming one wall 104 may be configured differently from the intelligent glass panel on or forming another wall 104. As discussed herein, in an embodiment, the intelligent glass panel 110 of the door 102 and the intelligent glass panel 112 of the walls 104 may each be configured to display content intended to be viewed from outside the microwave 100.

In embodiments, the intelligent glass panels 110 and/or 112 may be configured to display content projected thereon (e.g., the microwave 100 may include a projector or an external source may be used to project content for display on the intelligent glass panels 110 and/or 112). For example, the panels 110 and/or 112 may be configured to display content such as would be seen on a television. Furthermore, the microwave 100 may be equipped with means for receiving an input (e.g., DVD) and displaying the content from the input on the panels 110 and/or 112. In another embodiment, the microwave 100 may receive input from a mobile device, which may be displayed on the panels 110 and/or 112. Input from the mobile device may include but shall not be limited to text messages, photos (such as photo slide shows), and videos. Where a user may desire to engage in a video discussion with a third party, the microwave may project the video of the third party onto the panels 110 and/or 112. Further, sensors (e.g., cameras) may be located at or near the panels 110 and/or 112 for capturing video of the user, which may be transmitted to the mobile device according to methods known in the art. The user may also be shown displays that relate to the cooking process, including status alerts and interactive augmented reality icon images which may assist in the ease of operation and enhance the overall cooking experience.

While FIG. 2 shows the various panels of the door 102 (e.g., panels 106 and 110) and the walls 104 (e.g., panels 108 and 112) as being separately visible, in embodiments, these panels may be seamlessly incorporated. In some embodiments, one or more of the above described panels forming the door 102 and the walls 104 may be omitted (e.g., in embodiments, the walls 104 may comprise only the intelligent glass panels 112 and be devoid of the frequency selective surface panels 108).

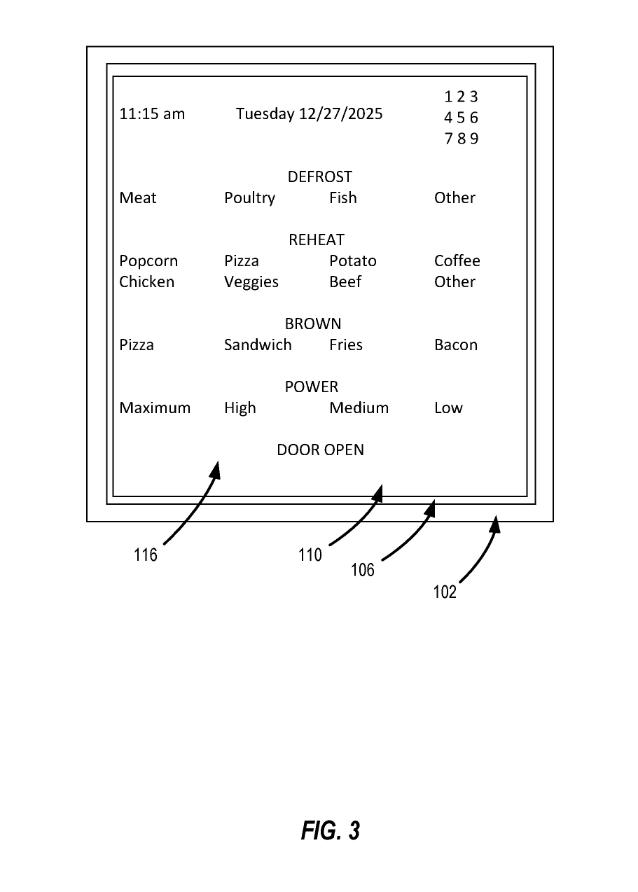

In an embodiment, a control panel 114 (FIG. 2) may be provided adjacent the door 102 (e.g., underneath the door 102) or elsewhere. The control panel 114 may include various knobs and buttons 114A that a user may use to operate the microwave 100 as desired. In another embodiment, the control buttons 114A may be omitted and the functionality thereof may be incorporated in the intelligent glass panel 110 (and/or the intelligent glass panel 112). For example, and as shown in FIG. 3, in an embodiment, the intelligent glass panel 110 may include a touch screen display on which an interface 116 (e.g., a touch interface) is provided to allow the user to operate the microwave 100 as desired.

In some embodiments, the interface 116 may be gesture controlled. The skilled artisan understands that gesture control devices, known in the art, recognize and interpret movements of the human body in order to interact with and control a computing system without physical contact. For example, in an embodiment, the user may put up two fingers in front of intelligent glass panel 110 (and/or the intelligent glass panel 112); the interface (e.g., the gesture controlled interface) 116 may read this input and the microwave controller may resultantly cause the microwave 100 to heat the consumable for two minutes. Or, for example, the user may swipe his finger in a downward direction in front of the intelligent glass panel 110 (and/or the intelligent glass panel 112), and the interface 116, in conjunction with the microwave controller, may cause the microwave 100 to power off. While gesture control may be incorporated in the intelligent glass panels 110 and/or 112 by any means now known or subsequently developed, in an embodiment, infrared gesture sensors disposed on or proximate the microwave 100 may be used to allow the interface 116 to detect movement of the user proximate the microwave 100. In some embodiments, the microwave 100 may alternately or additionally include voice recognition capabilities and a user may provide voice commands to cause the microwave 100 to function as desired. Alternately or additionally, in other embodiments, iris recognition software may be associated with the interface 116 and the user may look at an option displayed on the intelligent glass panels 110 and/or 112 to cause the microwave controller to implement same. It is also envisioned that, in embodiments, the microwave 100 may be controllable using a remote controller.

Additionally, gesture recognition functionality is not limited to a user's movement. The interface 116 may be configured to read movements of the consumables to effect a change in the microwave output. For example, if a user were microwaving a bowl of ramen noodles, the interface 116 may detect movement of the noodles (e.g., bending), or water bubble patterns once the water begins to boil. Based on the detected movements, the interface 116 in conjunction with the microwave controller, may cause the microwave to, for example, reduce the power of the microwave, the amount of cooking time, change the movement of the rotating tray, etc.

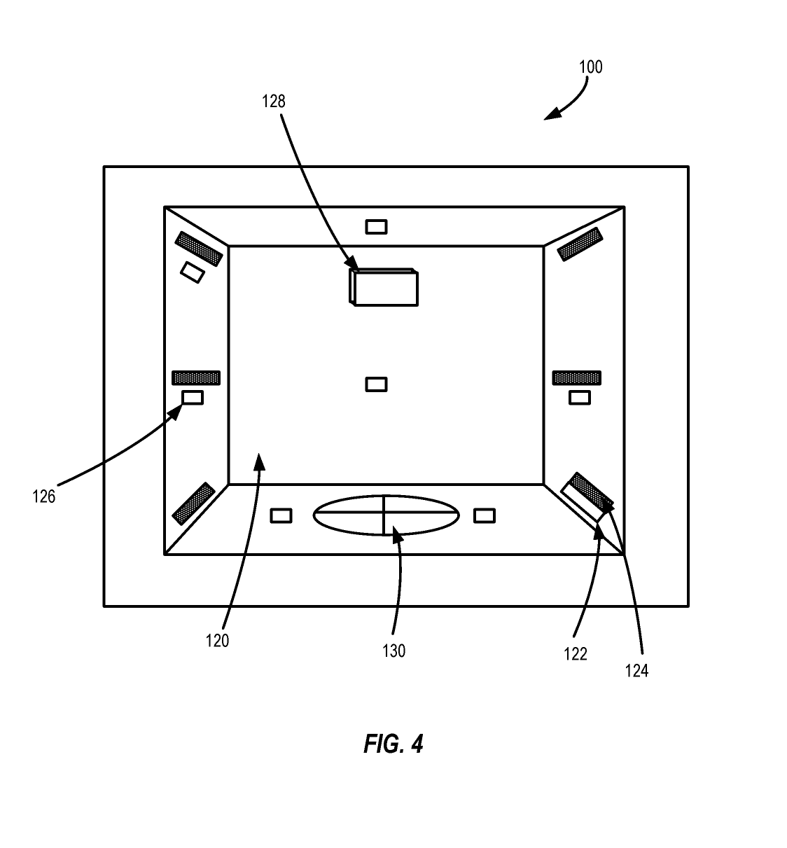

FIG. 4 shows a cavity 120 of the microwave 100. The cavity 120 may be accessed by opening the door 102. In embodiments, the user may depress a button which unlatches the door 102 and allows the cavity 120 to be accessed. In other embodiments, the user may use the interface 116 (e.g., a touch interface, gesture controlled interface, voice recognition interface, iris recognition interface, thermal infrared array, etc.) to cause the door 102 to open. As noted, the microwave 100 may have a controller and associated programming to allow for the interface 116 to be used by the user to control the operation of the microwave 100.

The cavity 120, as shown, may in an embodiment include one or more microwave input apertures 122. The input apertures 122 may serve to supply microwaves (e.g., microwaves 30 in FIG. 1) generated by a microwave source (e.g., a magnetron) into the cavity 120 via an antenna or other waveguide. The input apertures 122 may, in embodiments, be selectively openable and closeable. For example, in embodiments, one or more input apertures 122 may have associated therewith a moveable closing member 124 configured to selectively close (e.g., partially or fully) the input aperture 122. The closing member 124 may comprise aluminum, stainless steel, or other metals or non-metals (e.g., tuned rubber foam manufactured by MAST Technologies and comprising silicone and/or nitrile) configured to block the microwaves 30 from entering the cavity 120 via the input aperture 122. The microwave controller may, in embodiments, cause the input apertures 122 to selectively open and close (e.g., mechanically using a motor or other means) to facilitate the desired operation of the microwave 100. For example, when the browning of a consumable is being effectuated using a browning plate or the microwave compartments as discussed below, the microwave controller may open the input apertures 122 facing the browning plate and/or the microwave compartments and close off one or more of the remaining input apertures 122. Thus, the input apertures 122 may be used to strategically direct the microwave energy to specific portions of the cavity 120. The resulting actions of the input aperture's 122 resolved movement is a selectively parametric equalized Faraday shield.

In an embodiment, the microwave 100 may comprise one or more sensors 126. The sensors 126 may be located within the cavity 120 at or proximate the inner surfaces of the door 102 and/or the walls 104 (e.g., atop the inner surfaces of the door 102 and walls 104 and/or embedded therein). In embodiments, one or more sensors 126 may also be provided on or in a browning plate and/or microwave compartment (discussed further below) useable in the microwave 100. Further, in embodiments, one or more sensors 126 may be configured on an outer surface of the microwave 100.

The sensors 126 may be contact and/or non-contact sensors and may be communicatively coupled to the microwave controller (e.g., via wires or via wireless connection). The microwave controller may, in embodiments, obtain readings from the sensors 126 and cause same to be conveyed to the user (e.g., over the interface 116); the user may thus modify operation of the microwave 100 based on the sensor readings communicated to the user. In some embodiments, and as discussed herein, the microwave controller may automatically modify the operation of the microwave 100 in response to the readings obtained from the sensors 126. The artisan will appreciate that the sensors 126, where disposed within the cavity 120, may be capable of operating (i.e., may be configured to operate) in a microwave environment and/or may be configured to withstand radiation in the microwave cavity 120. Many such sensors 126 are commercially available today. The sensors 126 include, however, sensors that are subsequently developed.

The sensors 126 may, in embodiments, be cameras configured to image the consumable being microwaved. For example, the camera may capture an image of various portions of the consumable being microwaved (including, for instance, the underside thereof) and cause these images to be displayed on the intelligent glass panel 110 and/or 112. The user may alter the operation of the microwave 100 (e.g., decrease a power level of the microwave 100) based on these images displayed on the intelligent glass panel 110 and/or 112.

Alternately or additionally, the sensors 126 may, in embodiments, comprise temperature sensors (e.g., thermal imaging cameras). For example, in an embodiment, one or more of the sensors 126 may comprise a non-contact infrared sensing array configured to measure temperature profiles of the consumable being microwaved. The thermal imaging may, for example, indicate the current temperature of various portions of a consumable (e.g., where the consumable is a pizza, the temperature profile may indicate the temperature of the crust, the cheese layers, the toppings on the surface and within the cheese layer, etc.). As discussed herein, the microwave controller may cause one or more portions of the consumable (or one or more consumables) to be heated more than another portion based on the readings obtained by the sensors 126. For example, where the thermal profiles obtained via the sensors 126 indicate that a consumable placed on a left side of the cavity 120 is hot but that a consumable placed on the right side of the cavity 120 is relatively cold, the microwave controller may close the input openings 122 on the left side of the cavity 120 and direct the microwaves 30 through the input openings 122 on the right side of the cavity 120. Or, for example, where the thermal profile obtained via the sensors 126 indicates that a consumable is cooked at the top but is relatively cold at the bottom, the microwave controller may cause a browning plate (discussed further below) to provide additional heat to the bottom portion of the consumable.

In an embodiment, one or more of the sensors 126 may be bacteria sensors. The bacteria sensors may determine whether a consumable placed within the microwave cavity 120 is bacteria-ridden and should not be consumed. Where the amount and/or types of bacteria in the consumable renders the consumable inedible (and/or otherwise endangers the health or well-being of the user consuming the consumable), the microwave controller may, based upon the readings from the bacteria sensors, generate an alarm condition. For example, the microwave controller may cause an audible or visual alarm to be conveyed to the user via the interface 116. Or, for instance, the microwave controller may power off the microwave 100 until the consumable is removed from the cavity 120. In some embodiments, the microwave 100 may include CARDs (i.e., chemically actuated resonant devices) augmented with carbon nanotubes, such as the CARDs recently developed by the Massachusetts Institute of Technology chemists. The CARDs may be configured to detect gases emitted by rotting consumables to identify those consumables that should not be consumed.

In some embodiments, the microwave 100 may employ material sensing technology (such as the material sensing technology developed by Changhong H2, SCiO, TellSpec, etc., or other material sensing technology now known or subsequently developed) configured to identify the consumable being microwaved and the constituents thereof. For example, in an embodiment, one or more of the sensors 126 may be spectroscopic sensors having a near-infrared light source associated therewith. Once a consumable is placed within the microwave cavity 120, the source may shine the near-infrared light on the consumable and cause the molecules of the consumable to excite. The sensor may then analyze the light reflected off the vibrating molecules of the consumable. As understood by the skilled artisan, the light reflected by one consumable will be different from the light reflected by another consumable. The microwave controller may thus identify the consumable and the constituents thereof by the unique optical signature of the consumable. Upon identification of the consumable, the microwave (e.g., via electronics therein) may access a database, which may be stored locally or remotely and accessed over a network, to retrieve information regarding the consumable. For example, the information may include caloric information and/or whether the consumable complies with certain specifications (e.g., gluten free, nut free, etc.). In other embodiments, information about the consumable may be unavailable in the database due to, for example, the consumable being homemade rather than purchased. Here, the spectroscopic sensor may be able to sufficiently identify, without the use of a database, specific information about the consumable, including but not limited to caloric information, constituents making up the consumable, etc. The consumable-specific information may then be transmitted to the user e.g., via the panels 110 and/or 112, on the user's mobile device, etc.

In an embodiment, the sensors 126 may include one or more olfactory sensors (e.g., conductive polymer sensors, tin-oxide gas sensors, quartz-crystal micro-balance sensors, etc.). Where the olfactory sensors indicate that a bad odor is emanating from the microwave cavity 120, the microwave controller may start a cleaning cycle as discussed below. In embodiments, where the microwave controller determines using the olfactory sensors that bad odor is emanating from a consumable being microwaved, the microwave controller may warn the user and/or automatically power off the microwave 100.

In embodiments, the sensor 126 may be a smoke detector (e.g., an optical or other smoke detecting sensor). Where a consumable being microwaved within the cavity 120 is burning, or where smoke is otherwise present within the cavity 120 (e.g., from a short circuit), the microwave controller may cause an alarm to be generated apprising the user of same and/or automatically power off the microwave 100 for a time period.

It shall be understood by those of skill in the art that the microwave 100, via electronics known in the art, which may include networking devices, transmitters, processors, microprocessors, programming, etc., may be in data communication with other smart-technology enabled devices to provide a seamless user experience among the various devices utilized by the user. For example, the microwave 100 may be in data communication with devices utilizing the smart glass technology, such as those described in U.S. Patent App. No. 62/450,769, filed Jan. 26, 2017 (attached as Appendix B) to transmit information to the user. Communication may occur through the door 102. For example, IRDA infrared and visible LED modulation may allow for communication through the door 102 which would not otherwise be available due to RF isolation in the microwave chamber.

In an embodiment, the microwave 100 may have a self-cleaning feature. The self-cleaning may be effectuated using an openable vessel 128 (see FIG. 4). The vessel 128 may be manufactured using materials that reflect the microwaves 30, and may have a door or other cover that can be caused to be moved by the microwave controller based on the determination of an unsanitary condition. The vessel 128 may contain an agent (e.g., lemon water, vinegar, etc.) capable of sanitizing the microwave cavity 120. Where the microwave 100 is not presently being used to microwave a consumable and the sensors 126 (e.g., bacteria sensors, olfactory sensors, etc.) indicate that the microwave cavity 120 (e.g., one or more of the surfaces of the door 102 and walls 104 forming the cavity 120) includes remnants of foods and drinks and/or is otherwise dirty, the microwave controller may cause the vessel 128 to open and automatically power on the microwave 100 for a given duration (e.g., five minutes, ten minutes, etc.). The steam generated by the boiling of the sanitation agent in the vessel 128 may serve to sanitize the cavity 120. In embodiments, once the cleaning cycle is completed, the microwave controller may obtain another set of readings from the sensors 126 to ensure that the microwave cavity 120 is clean; where the sensor readings indicate that the microwave cavity 120 continues to be dirty, the microwave controller may start another cleaning cycle and continue to do so until the microwave cavity 120 is suitably clean. In embodiments, the microwave controller may also cause a visual, audible, or other alarm to be conveyed to the user to apprise the user that the microwave 100 is in need of cleaning. The sensors 126 may, in embodiments, further be used to ensure appropriate heating and/or cooking of the consumable within the microwave cavity 120 (e.g., where the bacteria sensor determines that a consumable contains an unsuitable level or type of bacteria even after the consumable is microwaved, the microwave controller may apprise the user of same and/or microwave the consumable for an additional time period to kill the bacteria therein). Additional self-cleaning and disinfecting methods may be provided via the use of ultraviolet light waveforms, such as UV-A, UV-B, and/or UV-C.

In an embodiment, the openable vessel 128 may be located within, or attached to, removable cooking containers or accessory devices for the purpose of altering the consumable, rather than acting as a part of a self-cleaning feature. Here, instead of a sanitation agent, the vessel 128 may contain one or more additive cooking ingredients, such as salt, spices, meat tenderizer, liquids (e.g., water, wine, milk, etc.), or other ingredients. The vessel 128 may be programmed to deliver the additive cooking ingredients to the consumable during the cooking process. For example, the vessel 128 may be configured to deliver salt to a container of water once it is determined (e.g., via a sensor 126 as described herein) that the water is boiling.

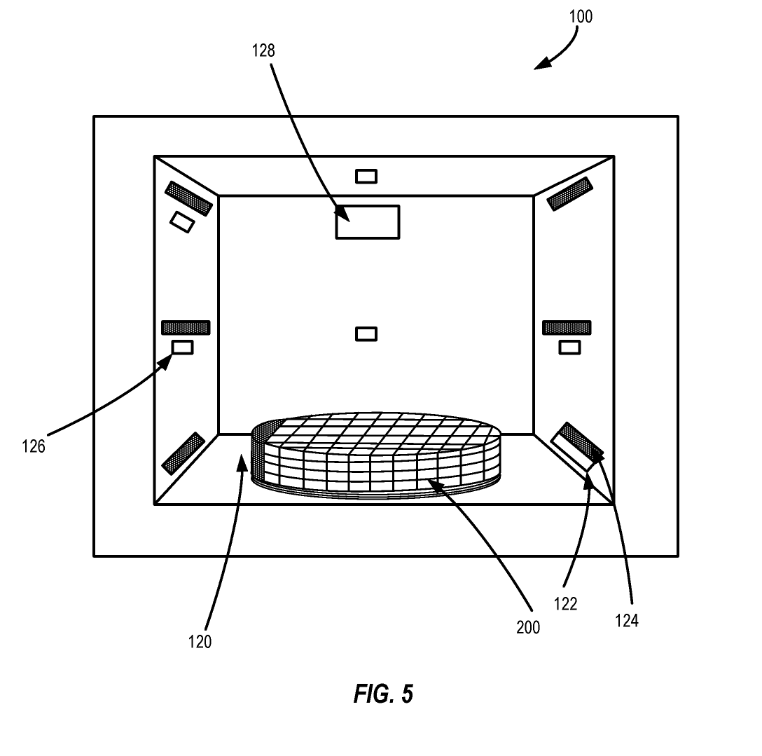

In embodiments, the microwave 100 may include a rotating mechanism 130. A conventional microwave tray (made, e.g., of tempered glass or other suitable materials) may be situated on the rotating mechanism 130, and one or more consumable(s) to be microwaved may be placed thereon. As discussed above, and for other reasons known to the artisan, one or more consumables situated on the conventional rotating tray located atop the rotating mechanism 130 may not heat up and/or cook evenly. A selective browning tray 200 (also referred to herein as a selective crisping tray, see FIG. 5) may, in embodiments, address this problem at least in part. The selective browning tray 200 may be situated on the rotating mechanism 128; however, the browning tray 200 may also be used in microwaves that do not include a rotating mechanism within their respective microwave cavities.

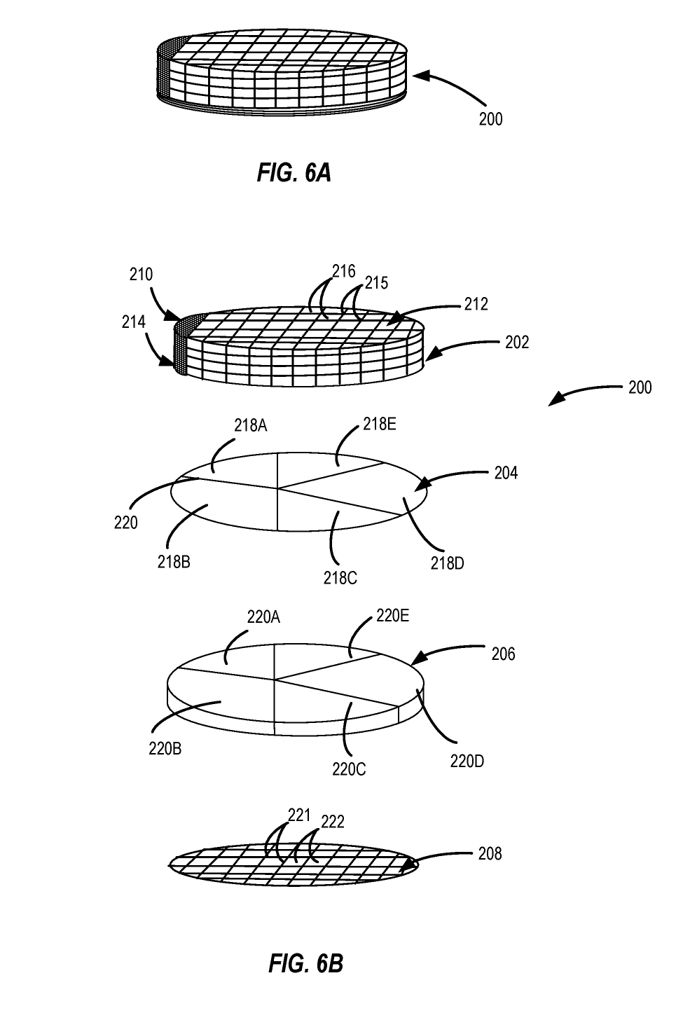

FIG. 6A shows the selective browning tray 200 outside the microwave cavity 120, and FIG. 6B shows an exploded view thereof. The browning tray 200 may, in embodiments, be multi-layered, as shown in the figures. Specifically, the browning tray 200 may, in an example embodiment, include a first layer 202, a second layer 204, a third layer 206, and a fourth layer 208. In an embodiment, one or more of these layers may be omitted, and in other embodiments, the tray 200 may include additional layers. In embodiments, the browning tray layers may be removable and constructed having predetermined material attributes (e.g., ferromagnetism, thickness, transparency, color tin, grid pattern, size, etc.) to provide varying levels of preconfigured excitation attenuation (e.g., browning effect).

The first (or the top) layer 202 may have a microwave blocking pocket 210 and a selective microwave transmission portion (or selective energy transmission portion) 212. The microwave blocking pocket 210 of the top layer 202 may, in an embodiment, be made of thermal resistive materials (e.g., tuned frequency absorbing rubber foam manufactured by MAST technologies) that reflect or significantly attenuate microwaves (e.g., microwaves 30 in FIG. 1). The microwave blocking pocket 210 may, in embodiments, house electronics 214, such as a PCB, a micro-motor, a microprocessor, a memory having programming instructions configured to cause the browning plate 200 to function as described herein, etc. The browning tray electronics 214 (e.g., the browning tray controller) may, in embodiments, be coupled (e.g., communicatively coupled over a wired or wireless network) to the microwave controller. The browning tray electronics 214 may serve to control the operation of the browning tray 200, as discussed herein. While the pocket 210 is shown as being on an end of the first layer 202, in embodiments, the pocket 210 may be at the center thereof or elsewhere.

The selective microwave transmission portion 212 of the tray top layer 202 may be configured to selectively attenuate and/or transmit microwaves 30 generated by the microwave magnetron. In a blocking (or attenuating) mode, the selective microwave transmission portion 212 of the tray top layer 202 may preclude microwaves 30 within the microwave cavity 120 from reaching the second layer 204 through the first layer 202. In a transmission mode, the selective microwave transmission portion 212 may allow at least some microwaves 30 to transmit therethrough and reach the second layer 204.

In more detail, in an embodiment, the selective microwave transmission portion 212 may include a mesh or grid 215 having openings 216. The openings 216 of the grid 215 may be dynamically resized to allow for the selective transmission and/or blocking of the microwaves 30 through the selective microwave transmission portion 212. The artisan understands that the wavelength of microwaves 30 is relatively large (around 12.5 cm). Therefore, where the length and/or width of the openings 216 is small in comparison (e.g., on the order of 1-50 mm each), the selective microwave transmission portion 212 may block the microwaves 30 and preclude them from reaching the second layer 204 through the first layer 202. Alternately, where the length and/or width of the openings 216 of the grid 215 is relatively large (e.g., a few cm or more), the microwaves 30 may pass through the selective microwave transmission portion 212 and contact the second layer 204.

The dynamic resizing of the grid openings 216 may be effectuated in any number of ways. In one embodiment, for example, the grid 215 forming the selective microwave transmission portion 212 may be made of rods of aluminum, stainless steel, or other metals or non-metals that reflect microwaves 30, and the grid 215 may be operatively coupled to a micro-motor housed in the microwave blocking pocket 210. The browning tray controller may employ the micro-motor to dynamically resize the one or more openings 216 as appropriate (e.g., the micro-motor may push, pull, or otherwise reconfigure the rods making up the grid 215 so as to enlarge or shrink the openings 216 to selectively transmit and block the microwaves 30). Another example of grid resizing includes the use of variable excitation frequencies other than the primary standard 2.45 GHz cooking mode. Here, an excitation frequency of, e.g., 40 MHz may be used to rapidly defrost meat before a cooking stage is performed. Accordingly, during the defrost stage, the grid size may be widened to allow lower RF frequencies to reach select areas within the oven to allow only the meat to defrost.

In an embodiment, the mesh or grid 215 may be made using smart materials. Smart materials are materials having one or more properties that can be changed significantly in a controlled fashion by external stimulus, such as an electric field, a magnetic field, temperature, moisture, etc. For example, in an embodiment, the grid 215 may be manufactured using “muscle wire” (or other smart material(s)). The artisan understands that muscle wire is typically made using Nitinol (a nickel-titanium alloy) and undergoes structural change at the atomic level upon the application of an external stimulus. For example, application of AC or DC power to muscle wire may realign the crystal structures therein and may thereby cause the muscle wire to contract. When the power is turned off, the muscle wire may return to its original shape. In an embodiment, the browning plate controller may cause current to pass through the grid 215 to rearrange the grid openings 216 to, e.g., decrease the area of same such that the grid 215 precludes microwaves 30 from passing therethrough to the second layer 204. Alternately, when transmission of the microwaves 30 through the microwave transmission portion 212 is desired (for reasons discussed below), the browning plate controller may cut power to the Nitinol wires to cause same to return to their original state, thereby increasing the size of the openings 216 and allowing the microwaves 30 to pass through to the second layer 204.

The artisan will appreciate that the mesh 215 with its openings 216 may allow for varying levels of transmission of the microwaves 30. For example, the openings 216 may be made relatively small so as to allow only a small percentage of the microwaves 30 traveling towards the second layer 204 to contact same; alternately, the openings 216 may be made relatively large so that a larger percentage of the microwaves 30 traveling towards the second layer 204 pass through the openings 216 and contact the second layer 204. While microwaves 30 are identified as a specific example, the artisan will appreciate that the selective energy transmission portion 212 may likewise be configured to selectively block and transmit energy at other frequencies.

In an embodiment, the selective microwave transmission portion 212 may, instead of the mesh 215, comprise one or more ferrofluids. A ferrofluid is a stable colloidal suspension of superparamagnetic iron oxide nanoparticles. Put simply, a ferrofluid is a liquid having magnetic nanoparticles. In these embodiments, the ferrofluid constituting the selective microwave transmission portion 212 may be one that blocks microwaves 30. The ferrofluid itself may be housed in a container that transmits microwaves 30 (e.g., the selective microwave transmission portion 212 may be a tempered glass plate containing ferrofluid). The container housing the ferrofluid may have one or more electromagnets at its edges (e.g., electromagnets that can be activated by the browning tray 200 controller). In an unexcited state, the ferrofluid may form a thin layer within the container and block the microwaves 30 from passing through the selective microwave transmission portion 212 to the second layer 204. When transmission of the microwaves 30 through the microwave transmission portion 212 is desired, the browning tray controller may activate the electromagnets which may attract and pull the ferrofluid towards the edges of the container housing the ferrofluid. The microwaves 30 may therefore pass through the selective microwave transmission portion 212 and contact the second layer 204. In some embodiments, different sections of the selective microwave transmission portion 212 may employ different methods to selectively block and transmit the microwaves 30 (and/or energy at other frequencies). In this way, the amount of microwaves 30 that contact the second layer 204 may be controlled.

Attention is directed now to FIG. 6B. The second layer 204, also referred to herein as the browning layer or the crisping layer, may be made of thermally conductive materials (such as aluminum, stainless steel, or other suitable metals and non-metals). In an embodiment, the second layer 204 may be divided into sections (e.g., sections 218A-218E). Each section constituting the second layer 204 of the browning tray 200 may be made of thermally conductive materials, and, in embodiments, the thermal conductivity of one section (e.g., section 218A) may be different from the thermal conductivity of another section (e.g., section 218B).

The one or more sections (e.g., sections 218A-218E) of the second layer 204 may, in an embodiment, be thermally isolated from each other. For example, as shown in FIG. 6B, a thermally resistive material (e.g., silicone infused rubber, ceramics, etc.) 220 may be disposed at the junction of two adjacent sections (e.g., at the interface of section 218A and 218B). Or, for example, a gap may be provided between each section (e.g., section 218A) and the sections adjacent thereto (e.g., section 218B). Thus, while the microwave 100 is in operation as discussed herein, each section 218A-218E of the browning layer 204 may, in embodiments, have a temperature that is different from the temperature of another section.

In embodiments, the second layer 204 may have one or more sensors (e.g., sensors 126 discussed above) on the surface thereof and/or embedded therein. For example, in an embodiment, each section 218A-218E of the second layer 204 may include one or more of a temperature sensor (such as a non-contact infrared thermal imaging sensor), a bacteria sensor, a camera, an olfactory sensor, etc.

The third layer 206 may be made of microwave absorbing materials. The microwave absorbing layer 206, in an embodiment, may include segments 220A-220E, and each segment of the microwave absorbing layer 206 may correspond to a section of the browning layer 204. Specifically, the browning layer 204 may be disposed atop the microwave absorbing layer 206 such that segment 220A of the microwave absorbing layer 206 corresponds to and contacts section 218A of the browning layer 204, segment 220B corresponds to and contacts section 218B, segment 220C corresponds to and contacts section 218C, segment 220D corresponds to and contacts section 218D, and segment 220E corresponds to and contacts section 218E.

In an embodiment, the microwave absorbing material(s) forming one segment (e.g., segment 220A) of the microwave absorbing layer 206 may be different from the microwave absorbing material(s) forming another segment (e.g., segment 220B) of the microwave absorbing layer 206. For example, in embodiments, the microwave absorbing layer 206 may comprise rubber embedded ferrite (or other suitable materials), and the Curie point of the rubber embedded ferrite forming one segment (e.g., segment 220A) may be different from the Curie point of the rubber embedded ferrite forming another segment (e.g., segment 220B). The ferrite compositions may include, for example, Li₂O₃, Mn₂O₃, MGO, ZNO, Fe₂O₃, mixtures thereof, etc. As discussed herein, each segment 220A-220E of the microwave absorbing layer 206 may be configured to selectively heat up a corresponding section of the browning layer 204.

To illustrate, consider, for example, an embodiment where each microwave absorbing layer segment 220A-220E is manufactured using rubber embedded ferrite. When microwaves 30 contact the microwave absorbing layer 206, e.g., segment 220A thereof, magnetic losses may be created which may in-turn create heat. This heat may be transferred by the segment 220A of the microwave absorbing layer 206 to the corresponding section 218A of the browning layer 204. When the Curie temperature of the ferrite material comprising the segment 220A is reached, the segment 220A may become paramagnetic (i.e., the magnetic losses may decrease substantially), which may cause the temperature of the segment 220A to drop. When the temperature of the segment 220A drops, it may again absorb microwaves 30 and heat up the corresponding section 218A of the browning layer 204. In this way, while the microwave is powered on and the microwaves 30 are contacting the segment 220A of the microwave absorbing layer 206, the temperature of the corresponding section 218A of the browning layer 204 may be generally maintained. As noted, the segments 220A-220E of the microwave absorbing layer 206 may have different Curie points, and so these segments 220A-220E may provide varying levels of heat to the sections 218A-218E corresponding thereto. Thus, the temperature of one section of the browning layer 204 (e.g., section 218A) may be different from the temperature of another section (e.g., section 218B) even where all the segments 220A-220E of the microwave absorbing layer 206 are contacting the microwaves 30 generally uniformly. For example, the Curie points of the segments 220A and 220B may be such that when the microwave absorbing layer 206 is absorbing microwaves, the section 218A of the browning plate 204 heats up to 100 degrees Celsius whereas the section 218B of the browning plate 204 heats up to 300 degrees Celsius (or another temperature). As such, in embodiments, each section 218A-218E of the browning layer 204 may be configured for the heating and/or cooking (including browning) of a particular consumable or set of consumables (e.g., section 218A may be configured for the heating and/or cooking of chicken, section 218B may be configured for the heating and/or cooking of vegetables, section 218C may be configured for the heating and/or cooking of beef, etc.). Further, as noted above, the thermal conductivity of one section (e.g., section 218A) of the browning layer 204 may be different from the thermal conductivity of another section (e.g., section 218B) of the browning layer 204, and this characteristic of the browning layer 204 may also be used to configure particular sections of the browning layer 204 for different consumables and/or types of consumables.

The fourth layer (also referred to herein as the selective microwave transmission layer) 208 may, like the first layer 204, allow for the selective transmission of microwaves 30 (and other energy) therethrough. For example, the microwave transmission layer 208 may have a mesh 221 whose openings 222 may be dynamically resized as discussed above for the openings 216. Or, for instance, the microwave transmission layer may comprise ferrofluids that block the microwaves and which may be pulled to the sides of the layer to allow for the transmission of microwaves 30 through the fourth layer 208. The microwaves 30 may therefore selectively pass through the fourth layer 204 and contact the microwave absorbing layer 206.

In embodiments, unlike the first layer 202, the fourth layer 208 may be devoid of the pocket 210 for housing the electronics 214. In other embodiments, however, the electronics 214 may be housed in a pocket formed in the fourth layer 208 instead of the first layer 202; or, some electronics may be housed in a pocket formed in the first layer 202 and the remaining electronics may be housed in a pocket formed in the fourth layer 208. In some embodiments, the electronics 214 housed in the pocket of the first layer 202 may serve to control the operation of the fourth layer 204.

For use, in an example embodiment, the browning tray 200 may be configured as follows. The top layer 202 may be detachable from the browning tray 200 and a user may temporarily remove the top layer 202 to gain access to the upper surface of the browning layer 204 (specifically, the upper surfaces of the sections 218A-218E thereof). The second (i.e., browning) layer 204 may be upwardly adjacent and in contact with (e.g., secured to a top surface of) the third (i.e., the microwave absorbing) layer 206. The fourth layer 208 may be downwardly adjacent (e.g., secured to or otherwise disposed beneath) the microwave absorbing layer 206.

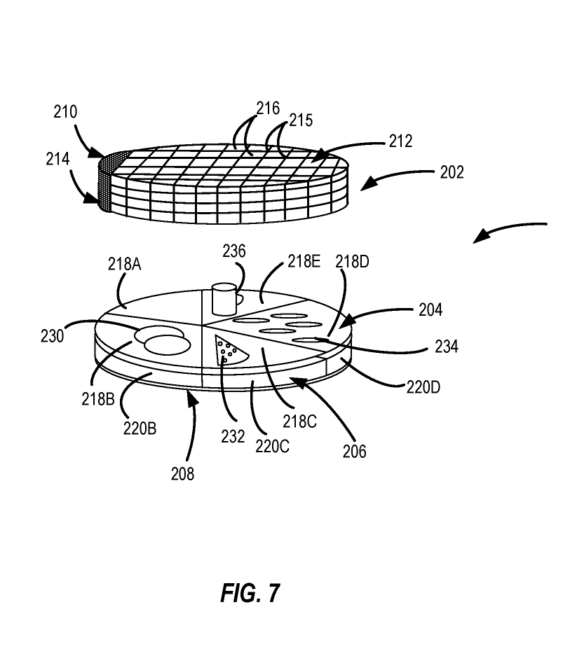

Focus is directed now to FIG. 7 to illustrate the workings of the browning tray 200, according to an example embodiment. The user may detach the top layer 202 from the tray 200 and place consumable(s) on the upper surface of the browning layer 204. For example, as shown in FIG. 7, the user may place consumable(s) 230 (e.g., whole potatoes) on section 218B of the browning layer 204, consumable 232 (e.g., a pizza slice) on section 218C of the browning layer 204, consumable 234 (e.g., French fries) on section 218D of the browning layer 204, and consumable 236 (e.g., a mug containing a coffee drink) on section 218E of the browning layer 204. The user may then reattach the top layer 202 to the tray 200 and place the tray 200 in the cavity 120 of the microwave 100. The user may use the control panel 114 (or interface 116) to activate the microwave magnetron.

Initially, the openings 216 of the grid 215 of the top layer 202 and the openings 222 in the grid 221 of the fourth layer 208 may be relatively large and may allow microwaves 30 to penetrate therethrough. Specifically, microwaves 30 may pass through the selective microwave transmission portion 212 of the first later 202 and contact the consumables 230-236 to directly heat same. Further, microwaves 30 may pass through the openings 222 in the grid 221 of the bottom/selective microwave transmission layer 208 and contact the microwave absorbing layer 206. The segments 220A-220E of the microwave absorbing layer 206 may absorb the microwaves and heat up the corresponding sections 218A-218E of the browning layer 204. As discussed above, one section (e.g., section 218A) of the browning layer 204 may have a different temperature than another section (e.g., 218B) of the browning layer 204 (e.g., because of the differing Curie points of the microwave absorbing layer segments 220A-220E and/or because of the different thermal conductivity of the browning layer segments 218A-218E). The consumables 230, 232, 234, and 236 may therefore heat up by virtue of: (a) the microwaves 30 passing through the top layer 202 which directly contact the consumables 230, 232, 234, and 236 on the browning layer 204 to heat up same; and (b) the microwaves 30 passing through the bottom layer 208 and absorbed by the microwave absorbing layer 206, which heat up the browning layer 204 from the bottom and transfer at least some heat to the consumables 230, 232, 234, and 236.

In still another embodiment, one or more compartments may be received into the microwave cavity 120. The compartments may be configured in a number of different sizes and shapes for heating, cooling, and/or cooking various consumables. The compartment(s) may be configured as an accessory to the microwave cavity, which may be equipped with means for mounting the compartment in positions within the microwave cavity. In embodiments, the compartments may be equipped with snaps, magnets, clips, or other fastening means for securing the compartment in or to the microwave cavity; the microwave cavity may be equipped with corresponding snaps, magnets, clips, or other fastening means. In one example, the compartment may include a female clip which may be received by an aperture formed into one or more of the walls of the microwave cavity. Supplemental and standby heating may be generated or assisted through the use of resistive electrical (e.g., nickel chromium particles, carbon fiber, carbon nanotubes, graphene, etc.) or photonic (e.g., LED, halogen, laser, IR, UV, etc.) heating elements. Supplemental and standby cooling may be generated or assisted through the use of air-flow management via mechanical, electro-mechanical, or electronic means. For example, piezo fans and/or Peltier thermo-electric coolers may be used to cool selected compartment areas within the oven.

The microwave cavity may be configured to simultaneously receive multiple compartments therein. For example, a first compartment may be configured to sit atop the rotating mechanism. A second compartment may be placed atop the first compartment, or atop the rotating means near the first compartment. Fastening means on a third compartment may be received into apertures in one or more of the walls. The third compartment may thus be vertically raised comparable to the first and second compartments. Energy to provide rotation movements can be harvested from cooking waveforms to provide a transducing effect from RF energy into physical motion.

Several different compartments may be manufactured to provide a spectrum of cooking, warming, and cooling capabilities. Each compartment may be specifically designed with a particular purpose in mind, and therefore may be equipped with selectively programmable filters (e.g., the mesh or grids described herein) which may allow predetermined amounts of microwaves through the filter for cooking or reheating a consumable. For example, in one embodiment, a particular compartment may be configured for reheating mashed potatoes. Through testing, it may be determined that a particular grid pattern and/or thickness may be ideal for accomplishing such reheating at typical microwave settings. Another compartment may be specifically designed for cooking bacon, another for boiling water, etc.

In one embodiment, a compartment may be included near the center of the microwave cavity for boiling water to produce steam. Another compartment, which may optionally have apertures formed in the bottom therein, may be secured to the side(s) of the microwave cavity as described herein such that it extends over the compartment holding the water. A consumable may be placed on the elevated compartment, and the microwave turned on to generate steam. Accordingly, it may be possible to steam consumables in a manner that has not yet otherwise been available.

In embodiments, the compartments may include an outer layer forming the rigid compartment and an inner layer. The inner layer may be, for example, a ferrofluid. Properties of the ferrofluid may be altered according to various stimulus which may allow a single compartment to be used for heating and/or reheating many types of consumables. For example, some users of a bacon tray may prefer that the bacon be more (or less) crispy. The user may be able to program, via compartment controllers located in the compartment which may be in communication with a user operating system (e.g., on the outside of the microwave), the correct grid pattern for crispy bacon. The compartment controllers may include, for example, magnetizable components which may be activated in order to influence the grid pattern formed by the ferrofluidic material.

Due to the different configurations of the grid patterns of the various compartments, a user may be able to perfectly cook and/or reheat multiple consumables at a time. For example, a user may select a first compartment for reheating a baked potato and a second compartment for cooking a chicken breast. The grid pattern in the first compartment may be such that very few microwaves are penetrating the compartment so that the potato does not reheat too quickly. Conversely, the grid pattern in the second compartment may be such that many microwaves are allowed to penetrate the compartment (and likewise the consumable) so that the chicken is appropriately cooked.

The compartments may optionally be formed integrally with the rotating mechanism 130 (which may optionally be a browning tray). For example, the rotating mechanism 130 may have a compartment for holding water selectively used for steam generation. When steam is desirable for cooking and/or reheating consumables, the compartment may be activated, e.g., by causing the microwaves to be directed towards the compartment, by causing the grid pattern to align such that the water heats up, etc.

The microwave controller, compartment controller, and/or the browning tray controller (hereinafter controller) may be in data (e.g., wired or wireless) communication with each other and may monitor the consumables 230-236 being microwaved via the sensors 126. For example, the controller may monitor the temperature of the consumables 230-236 (using, e.g., the temperature sensor readings). Where the temperature sensors indicate that the top surfaces of the consumables 230-236 are hot whereas their bottom surfaces are relatively cold, the browning tray controller may cause the size of the openings 216 in the top layer 202 to be dynamically readjusted so as to preclude microwaves 30 from transmitting through the selective transmission portion 212 of the top layer 202 and reaching the browning layer 204 (i.e., the openings 216 may be made smaller so as to preclude microwaves 30 for transmitting therethrough). Alternately, where the temperature sensors indicate that the bottom surfaces of the consumables 230-236 are hot whereas their top surfaces are respectively cold, the browning tray controller may dynamically readjust the openings 222 in the bottom/selective microwave transmission layer 208 so as to preclude microwaves 30 from reaching the microwave absorbing layer 206 and heating up the browning layer 204. The controller may, in this way, use the input from the sensors 126 to selectively control: (a) the microwaves 30 that heat up and/or cook the consumables 230-236 directly (i.e., the microwaves 30 that contact the consumables 230-236 after passing through the top layer 204); (b) the microwaves 30 that heat up and/or cook (e.g., brown) the consumables 230-236 indirectly (i.e., the microwaves 30 that contact the microwave absorbing layer 206 which in-turn heats up the browning layer 204). Similarly the controller may use input from sensors 126 to selectively control microwaves to the various compartments.

Because different sections 218A-218E of the browning layer 204 (and/or compartments) may have a different temperature, these sections 218A-218E may be used to simultaneously heat up and/or cook consumables (e.g., vegetables and meat) that would have had to be placed in the prior art microwave 10 for different lengths of time. In embodiments, based on the readings from the sensors 126 (e.g., the temperature sensors), the browning tray controller may further allow for one consumable (e.g., consumable 230) to directly receive more microwaves 30 than another consumable. For example, the controller may selectively adjust the openings 216 in the microwave transmission portion 212 such that more microwaves 30 transmit through the top layer 202 and contact the consumable 230 as compared to the consumable 232 (or another consumable), or are directed to one compartment rather than another.

The controller may also, in embodiments, vary the power level of the microwaves 100 adaptively based on the readings from the sensors 126. For example, where the user powers on the microwave 100 for a minute (or a different length of time) and the temperature profiles of the consumables 230-236 obtained from the temperature sensors indicate that the consumables will not reach a desired temperature within the allotted time, the controller may increase the power level of the microwave 100 (e.g., by increasing the duty cycle of the magnetron).

In some embodiments, when a consumable on the browning layer 204 reaches a desired pre-set temperature, the controller may communicate same to the user. For example, the controller may cause a message to be displayed on the intelligent glass panels 110 and/or 112 informing the user that the consumable is ready for consumption (e.g., that the pizza is ready to eat). Alternately or additionally, in some embodiments, the controller may communicate with the user via a mobile device of the user, as discussed below.

The browning tray 200 may, in embodiments, be powered using portable energy sources (e.g., batteries). In other embodiments, the browning tray 200 may draw power from the microwave 100 coupled to the standard AC outlet. In other embodiments still, the browning tray 200 may be powered wirelessly (e.g., using near-field/non-radiative and/or far-field/radiative techniques); for instance, the RF energy within the microwave cavity 120 may be used to power the browning tray 200.

The browning tray 200 may, in embodiments, be sold as part of a particular microwave. In other embodiments, however, the browning tray 200 may be modular and useable in various environments (e.g., in other microwaves and cooking devices).

The browning tray 200 may be dishwasher safe. In embodiments, the self-cleaning feature discussed above may be used also to ensure that the browning tray 200 is suitably clean (e.g., the self-cleaning feature may be automatically activated when bacteria sensors on the browning layer 204 indicate that the browning tray 200 is in need of cleaning).

In another embodiment, the rotating mechanism 130 may be fabricated from a material exhibiting adjustable viscosity and/or durometer characteristics. Here, the rotating mechanism may be configured for dynamic response to changes in the microwave environment. The rotating mechanism 130 may be fabricated from a material having a plurality of particles dispersed therein which are adaptable according to the microwaves received by the rotating mechanism 130. The particles may include micro- or nano-structures, such as those described in U.S. patent application Ser. No. 15/365,923, which is incorporated herein by reference in its entirety, which may respond to the microwaves by becoming more or less rigid, and thus affecting the viscosity and/or the durometer of the rotating mechanism 130.

In an embodiment, the rotating mechanism 130 is fabricated from glass (or a similar compound) having a plurality of the nano-particles dispersed throughout. The particles may, in a normal state, be such that the glass appears to a user as being “normal.” Upon receipt of microwaves having a particular frequency, the nano-particles may be affected in such a way that the viscosity of the glass is decreased, and the glass becomes more fluid.

It may be desirable for the particles to be specifically located in the rotating mechanism 130 such that the change in viscosity of the glass does not affect the overall function of the device 130. For example, consider that the rotating mechanism 130 is configured with a microwave compartment containing water. The compartment may be located between glass panels (e.g., the glass panels surrounding the compartment). When microwaves of certain frequencies excite the nano-particles which are strategically located around the rotating mechanism 130, such excitation may cause vents to open in the mechanism 130 allowing steam to exit the mechanism 130. The rotating mechanism 130 may have a door or other opening which may allow water to be replaced as necessary.

As noted, in embodiments, the microwave 100 may include intelligent glass panels 110 and 112 configured to display content. The content displayed on the intelligent glass panels 110 and/or 112 may, in embodiments, include generic content and specific content. The generic content may be, for example, cable channels, movies, music videos, documentaries, infomercials and other advertisements, etc. The specific content may be, for example, information about the operation of the microwave 100, information about the particular consumable being microwaved, information about a user's use of the microwave 100 as discussed below, etc. In some embodiments, while the microwave magnetron is powered off, a majority of the content displayed on the intelligent glass panels 110 and/or 112 may be generic content. The user may be allowed to customize the content displayed on the intelligent glass panels 110 and/or 112.

In embodiments, the microwave 100 may be configured to communicate (e.g., wirelessly or over a wired network) with other devices. For example, in an embodiment, the microwave 100 (and/or the browning tray 200) may include a networking device configured to allow the microwave 100 to communicate with the mobile device (e.g., a smart phone, laptop, or other device) of a user. The controller may further adaptively modify operation of the microwave 100 based on user preference. The microwave 100 may be configured to provide high level information to a user regarding the microwave function. The networking device may communicate with a mobile device the stages of a particular cooking cycle. For example, a user may place a consumable (here, for purposes of discussion, yeast rolls) in the microwave oven. The networking device may alert the user when the rolls are defrosted. The microwave may automatically, or alternately the user may direct the microwave to, turn to a low temperature to allow for rising of the rolls. Once the user has been alerted that the rolls have doubled in size, the microwave may automatically turn off. In another example, the networking device may communicate certain information regarding a consumable (e.g., thermal profile) so that the user may keep track of how the consumable is cooking. This may be especially beneficial where the user is completing multiple tasks at once, which may prevent the user from monitoring the cooking of the consumable through the door 102 of the microwave 100.

Further, in embodiments, a user may be allowed to download (e.g., over the web) a mobile application or other software associated with the microwave 100. When the user executes the mobile application on his mobile device (e.g., his smart phone, laptop, or other device), the application may ascertain a unique number (e.g., an Android ID, a Google Advertising ID, a Universal Device ID, etc.) identifying the device of the user and communicate same to the microwave 100 (e.g., to the controller). The user, in embodiments, may also be allowed to enter his microwaving preferences via the mobile application. For instance, a user A may indicate that he likes his coffee drink at 71 degrees Celsius whereas a user B may indicate that she likes her coffee drink at 85 degrees Celsius. When user A places his coffee cup in the cavity 120 of the microwave 100 (e.g., on section 218E of the browning layer 204 of the plate 200) for heating, the controller may wirelessly communicate with the mobile device of user A proximate the microwave 100 (e.g., on user A's person) and ascertain the device identification number thereof. The controller may therefore determine that the coffee drink in microwave 100 is user A's coffee drink, and using the sensors 126 (e.g., temperature sensors), automatically heat same up to 71 degrees Celsius. Alternately, where user B places her coffee cup in the microwave cavity 120, the microwave controller may communicate with user B's mobile device proximate the microwave 100 and automatically heat the coffee drink to 85 degrees Celsius. Additionally or alternately, in some embodiments, the microwave 100 may include a biometric sensor (e.g., a fingerprint, iris, or other scanner). When a user places a consumable within the microwave 100, the controller may use the biometric sensor to verify the identity of the user and microwave the consumable in line with the user's individualized preferences.

In embodiments, the microwave 100 may be coupled to network memory (e.g., the cloud) and track the consumables being microwaved by a particular user. For example, in an embodiment, the controller may identify the user placing the consumable within the microwave cavity 120 via the user's mobile device (and/or via biometrics), and employ material sensing technology as discussed above to identify the consumables being microwaved by the user. The microwave 100 (e.g., the controller using appropriate programming instructions) may then store the names of these consumables, along with the dates and times at which they were microwaved, in a profile of the user. The profile may also include additional information (e.g., the duration for which a particular consumable was microwaved, the temperature of the microwaved consumable, etc.). The user's profile may be stored on the cloud and may be accessible to the user (e.g., the user may be able to access the profile over the web). In some embodiments, the user profiles may be password protected and/or encrypted.

Such a profile may have several benefits. For instance, the user may, in embodiments, view his profile to determine the types of foods and/or drinks he has consumed in the last week, the last month, the last year, etc. The user may employ this information to improve or otherwise alter his eating and/or drinking habits. For example, where the user profile indicates that the user microwaves ten cups of coffee a day in the microwave 100 on average, the user may glean from his profile that his coffee intake is unsuitably high.

In some embodiments, one user may be able to leverage information in the profile of one or more other users. For example, in an embodiment, the microwave 100 (e.g., the interface 116) may have a default setting. When the user places a consumable within the microwave cavity 120 and selects the default setting, the controller may evaluate profiles of other users to determine how this consumable is being microwaved by others. For instance, when a user places a potato in the microwave cavity 120 and selects the default setting, the controller may evaluate other users' profiles to determine how a potato is typically microwaved by others, and automatically microwave the potato in line with the preferences of other users (e.g., if five users' profiles show that they microwave a potato on high power for three minutes and twenty users' profiles show that they microwave a potato on medium power for six minutes, the controller may select the latter as the default setting).

In some embodiments, the microwave 100 may have a shopping module. The shopping module may be configured to order consumables (e.g., over the web from the neighborhood supermarket or elsewhere) for the user automatically or based on user command. For example, where a user microwaves a dozen eggs in the microwave, the microwave 100 may use the shopping module to order and have delivered to the user's residence a dozen eggs.

In embodiments, the microwave 100 may be equipped with means for operating a stirring bar which may be placed in consumables for stirring during the heating/re-heating process. For example, the bottom wall 104 may have a magnet which may be turned on/off by the user. When the magnet is on, it may cause the stirring bar to rotate to stir the food. Alternately, the stirring bar may be caused to rotate as a function of the temperature of the consumable. For example, the stirring bar may be equipped with sensors which may detect the temperature of the consumable. When the sensor measures that the consumable is cool (e.g., below a certain threshold temperature), it may begin to stir; when the sensor measures that the consumable is warm (e.g., above a certain threshold temperature), it may stop stirring. The sensor may communicate with the controller to turn of the microwave when the threshold temperature (e.g., high temperature) is reached. The stirring bar may be especially useful for ensuring that the consumable (e.g., drinks) are both heated evenly and to the correct temperature.

Other extended-function devices may additionally, or alternately, be incorporated into the microwave to increase the microwave's function. For example, a remote piercing device may be equipped for electromagnetic or magnetic response to an input (e.g., a remote command, as discussed herein), which may cause the remote piercing device to move into position at a desired time to puncture an otherwise sealed container. Other types of extended function devices that may be programmed to respond to remote commands are contemplated within the scope of the invention.

Thus, as has been described, the functionality of the smart microwave 100 may be robust and may outmatch the functionality of microwaves (e.g., the microwave 10) in use today. Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. Not all steps listed in the various figures need be carried out in the specific order described.

The invention claimed is:

1. A smart oven for altering a consumable, comprising:
a thermally insulated chamber comprising five walls defining a cavity, and a door hingedly connected to one of the five walls; and
electronics housed within the chamber, the electronics comprising a controller in communication with memory;
wherein at least one of the walls comprises an intelligent glass panel configured to receive an input and provide a controlled output in response.

2. The smart oven of claim 1, wherein at least one of the walls comprises a transparent material comprising a panel having a frequency selective surface.

3. The smart oven of claim 1, wherein the door further comprises an intelligent glass panel.

4. The smart oven of claim 1, wherein the output of the intelligent glass panel is display content.

5. The smart oven of claim 4, wherein the input is received from a mobile device, the mobile device being in communication with the control and memory of the smart oven.

6. The smart oven of claim 5, further comprising a sensor for capturing input data from a user, the input data being transmitted from the smart oven to the mobile device.

7. The smart oven of claim 6, wherein the sensor is a camera.

8. The smart oven of claim 1, wherein the smart oven is a microwave.

9. The smart oven of claim 8, further comprising an input aperture, the input aperture being selectively altered between an open position and a closed position.

10. The smart oven of claim 9, wherein, in the closed position, the input aperture blocks microwaves from reaching the consumable.

11. The smart oven of claim 10, further comprising a sensor configured to detect a characteristic of the consumable.

12. The smart oven of claim 11, wherein the characteristic from the sensor is transmitted to the controller, the controller causing the input aperture to selectively open or close.

13. The smart oven of claim 12, wherein the sensor is a thermal sensing array for measuring a temperature profile of the consumable.

14. The smart oven of claim 9, further comprising a browning tray comprising a first layer having a selective energy transmission portion and a selective energy blocking portion, wherein the selective energy transmission portion selectively shifts between an attenuation mode and a transmission mode, wherein in the attenuation mode microwaves are blocked, an in the transmission mode microwaves are transmitted.

15. The smart oven of claim 14, wherein the browning tray further comprises a browning layer comprising a thermally conductive material.

16. The smart oven of claim 1, further comprising a sensor configured to detect information about the consumable.

17. The smart oven of claim 16, wherein the sensor is a bacteria sensor configured to determine an amount of bacteria in the consumable.

18. The smart oven of claim 17, wherein the sensor is further configured to generate an alarm if the amount of bacteria is above a predetermined threshold.

19. The smart oven of claim 18, wherein the alarm is the display content displayed on the intelligent glass panel.

20. The smart oven of claim 18, wherein the alarm is transmitted to a mobile device of a user.

21. The smart oven of claim 16, wherein the information about the consumable is at least one of: caloric information, and one or more constituent of the consumable.

22. The smart oven of claim 21, wherein the information about the consumable is displayed as the display content on the intelligent glass panel.

23. A smart oven for altering a consumable, comprising:
a thermally insulated chamber comprising five walls defining a cavity, and a door hingedly connected to one of the five walls;
at least one input aperture defined in one of the walls, the input aperture being selectively openable and closable; and
electronics housed within the chamber, the electronics comprising a controller in communication with memory;
wherein the electronics cause the at least one input aperture to selectively open and close in response to an input from a user.

24. The smart oven of claim 23, further comprising a sensor configured to detect at least one characteristic of the consumable, wherein the characteristic is transmitted to the electronics, and the electronics subsequently cause the input aperture to open or close based on the at least one characteristic.

25. The smart oven of claim 24, wherein the sensor is one of: a bacteria sensor, a thermal sensing array, an olfactory sensor, and a camera.

26. A smart oven for altering a consumable, comprising:
a thermally insulated chamber comprising five walls defining a cavity, and a door hingedly connected to one of the five walls; and
a browning tray, comprising:
a first layer comprising a selective energy transmission portion;
a second layer comprising a crisping tray; and
a third layer comprising at least one energy absorbing material;
electronics housed within the chamber, the electronics comprising a controller in communication with memory for controlling energy waves from the oven;
wherein the energy transmission portion is configured to selectively attenuate the energy waves.

27. The smart oven of claim 26, wherein the selective energy transmission portion comprises a grid having a plurality of openings, the openings configured to be dynamically resized.

28. The smart oven of claim 27, wherein the grid comprises one of a ferrofluid, a smart material, or an energy-reflective material.

29. The smart oven of claim 27, wherein the second layer comprises a first and a second section, the first and second sections being thermally isolated.

30. The smart oven of claim 26, further comprising a sensor configured to detect at least one characteristic of the consumable.
